(19) United States
(12) Patent Application Publication
(10) Pub. No.: US 2020/0334314 A1
(43) Pub. Date: Oct. 22, 2020

(54) EMERGENCY DISPOSAL SUPPORT SYSTEM

(71) Applicant: Beijing Yutian Technology Co. Ltd, Beijing (CN)

(72) Inventor: Libao YAN, Beijing (CN)

(21) Appl. No.: 16/687,092

(22) Filed: Nov. 18, 2019

(30) Foreign Application Priority Data
Apr. 17, 2019 (CN) 201910306912.4

(51) Int. Cl. G06F 16/9538; G06F 16/903

(52) U.S. Cl. CPC G06F 16/9538; G06F 16/90344; G06F 16/90348

(57) ABSTRACT

The present invention discloses an emergency disposal support system. The system provides users with the functions of realizing an intelligent matching search, and query result display and output of the existing emergency knowledge, emergency cases, emergency plans, laws and regulations in the system based on big data, GIS and other technologies. In the process of emergency disposal, users can acquire all kinds of existing emergency cases, emergency regulations and other information related to the subject of the emergency event in the database by manual or system automatic correlation of keywords. The above information is classified, sorted, displayed and output according to the needs of users to realize further improvement of the intelligent and visual support ability of emergency disposal on the basis of the existing emergency system, and to provide important support for users at all levels of emergency departments to deal with emergency events quickly, efficiently and collaboratively.

### TECHNICAL FIELD

The present invention relates to the field of emergency command, in particular to an emergency disposal support system.

### BACKGROUND ART

In recent years, China has severe public security situation, natural disasters and accidents occur frequently, public health events and social security events happen constantly, and there are still threats to national security. The Chinese government attaches great importance to disposal of emergency events, and especially after the 2008 Wenchuan Earthquake, the State Council has put forward higher requirements for emergency disposal. In order to improve the ability of emergency communication disposal, the Ministry of Industry and Information Technology has formulated and issued the Eleventh Five-Year Plan of National Emergency Communication, which proposes to build a set of emergency disposal support system to comprehensively enhance the command and dispatch ability of emergency communication in the country.

China attaches great importance to the development of emergency communication industry. The State Council prints and issues the Guiding Opinions on Accelerating the Emergency Industry, and clearly puts forward the focus on the development of emergency communications, emergency command and other emergency products and services, leading the direction of the development of the emergency communication industry and proposing new requirements. The Ministry of Industry and Information Technology attaches great importance to the construction of the national emergency communication system, organizes the preparation and revision of the National Communication Support Emergency Plan, successively implements the “Twelfth Five-Year” development plan for the national emergency communication, and makes the development of the emergency communication industry as an important task.

At present, the emergency disposal system built in the country has the ability of command and dispatch ahead of, in process of and afterwards events, but the system still lacks the intelligent and visual support ability, emergency knowledge database and assistant decision support ability of emergency disposal. Especially in the process of emergency disposal, assistant decision support such as historical case and emergency knowledge matching with emergency disposal is required.

### CONTENTS OF THE INVENTION

The present invention provides an emergency disposal support system, which further improves the intelligent and visual support ability of emergency disposal on the basis of the existing emergency system, and provides an important support for the rapid, efficient and cooperative disposal of emergency events for users at all levels of emergency departments.

The present invention is realized by the following schemes: an emergency disposal support system includes:

Configuration Management: Configuration management of database, port number, tables, usernames, passwords and search configuration keyword lists required for intelligent search is realized to provide configuration information for subsequent search functions.

Data Collection and Management: The data are extracted from the configured data sources, the extracted data are temporarily stored, and the extraction process log is recorded. The data after collection can be queried, maintained and re-collected to ensure the quality of the collected data. Information indexing of intelligent search is mainly to establish index terms uniformly for the relevant information within the search scope according to the key values, so as to facilitate the unified management of information and improve the search speed, recall rate and precision rate.

Template Management: The relevant search templates are preset according to the different needs of users, including search topics, keywords, search scope, output results and forms, and subsequently on this basis, users can modify or use directly. Search keywords can be separated by spaces and multiple keywords can be searched at the same time.

Search and Display: Intelligent search and display output mainly provides users with search according to keywords, search scope and output result set. Corresponding search results can be directly displayed, printed or exported to supply offline users for use.

Statistical Analysis: Statistical analysis of the search situation is made and can be displayed in the form of icons or tables. The number of search results of each type of emergency cases, laws and regulations, emergency plans, emergency knowledge and the total number of search results of the four categories are counted.

My Concern: The search results that users pay attention to are displayed by default, divided into four categories, including emergency cases, laws and regulations, emergency plans and emergency knowledge.

Hot Search: The top ten of the highest number of keywords searched by all users in the system are displayed, pushed to users actively to facilitate users to search quickly.

History Search: In the intelligent search, the search history of the current users is displayed by default.

GIS Display Service: According to the latitude and longitude information of the collected contents, the related content is marked on the GIS map by means of the corresponding icons and displayed in different colors. The existing functions of the GIS platform can be used to query, display, count and analyze these objects.

Furthermore, the template management mentioned also includes the parameters of template setting such astemplate names, keywords, time, search scope and event types.

Furthermore, the search and display mentioned also includes the ranking function of intelligent search results which is mainly to sort the search results according to time and result type but not to change the search results. The search results after sorting are helpful for users to use visually and conveniently.

Furthermore, the statistical analysis mentioned also includes multiple dimensional statistics according to search type, data source and collection type.

Compared with the existing technology, the present invention has the following advantages and beneficial effects:

The present invention provides the functions to realize an intelligent matching search, and query result display and output of the existing emergency knowledge, emergency cases, emergency plans, laws and regulations in the system based on big data, GIS and other technologies, greatly improving the intelligent decision support ability of the emergency system.

### ILLUSTRATIONS

In order to make contents of the present invention understood more easily and clearly, the present invention is further described in detail in accordance with specific embodiments of the present invention and figures, where

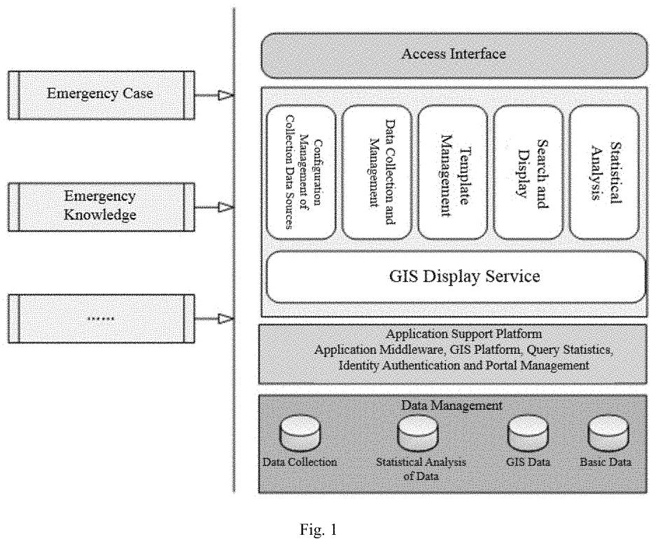

FIG. 1 shows the architecture of an emergency disposal support system in an embodiment of the present invention.

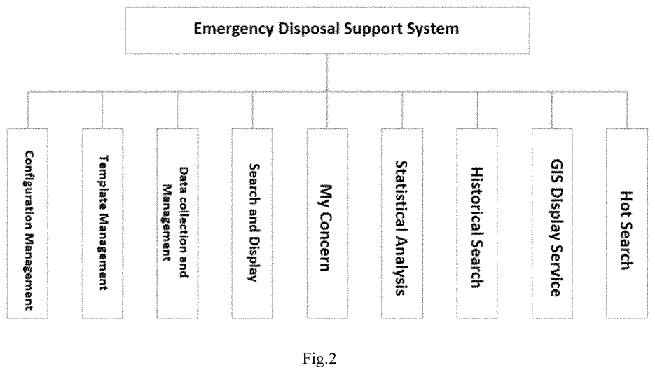

FIG. 2 shows the structure of an emergency disposal support system in an embodiment of the present invention.

### EMBODIMENTS

The following contents are detailed descriptions for embodiments of the present invention combined with figures. The following embodiments are used to describe the present invention but are not used to limit the scope of the present invention.

### Embodiment 1

As shown in FIG. 1, the present invention provides the architecture diagram of emergency disposal support system. The technical framework of the system adopts a technical architecture combining Spring, Struts, Hibernate and AngularJs. The system adopts service-oriented SOA software architecture and MVC design pattern, and adopts Web Service to realize interface development, information transmission and other technical schemes, so as to ensure the advancement and stability of the system development technology.

The overall logical framework of emergency disposal support system can be divided into data management layer, application support layer, GIS display service layerand business application layer from bottom to top. The above layers separately provide the corresponding data access and storage services, general supporting component services, basic support platform services to support development and operation, and specific business applications realized by underlying components and services, and show specific business applications to end users.

Data Management: The system configures the data sources which need to be collected separately through the data interface of the existing emergency system. The collected data include emergency knowledge, emergency cases, emergency plans and other data.

Application Support: Application middleware, GIS platform, query statistics, identity authentication, portal management and other services are provided.

GIS Display Service: The system collects and processes the data according to the configured collection data source. The system provides search application with the data for display and statistical analysis of operation information. Information with spatial data can be displayed on GIS platform.

Business Application: Data collection, statistical analysis, GIS display, configuration management, search and display and template management are mainly included.

### Embodiment 2

As shown in FIG. 2, the present invention provides the structural diagram of an emergency disposal support system. The system functions include:

Configuration Management: Configuration management of database, tables, usernames, passwords and search configuration keyword lists required for intelligent search is realized to provide configuration information for subsequent search functions.

Data Collection and Management: The data are extracted from the configured data sources, the extracted data are temporarily stored, and the extraction process log is recorded. The data after collection can be queried, maintained and re-collected to ensure the quality of the collected data. Information indexing of intelligent search is mainly to establish index terms uniformly for the relevant information within the search scope according to the key values, so as to facilitate the unified management of information and improve the search speed, recall rate and precision rate.

Template Management: The relevant search templates are preset according to the different needs of users, including search topics, keywords, search scope, output results and forms, and subsequently on this basis, users can modify or use directly.

Search and Display: Intelligent search and display output mainly provide users with search according to keywords, search scope and output result set, and realizes timing search or instant search. Corresponding search results can be directly displayed, printed or exported to supply offline users for use. The ranking functions of intelligent search results are mainly to sort the search results according to the time and result type, but do not change the search results. The search results after sorting are helpful for users to use visually and conveniently.

Statistical Analysis: The statistical analysis module of intelligent search is mainly used to make statistical analysis of searches, and can be displayed in the form of icons and tables, or exported to supply offline users for use.

GIS Display Service: According to the latitude and longitude information of the collected contents, the related content is marked on the GIS map by means of the corresponding icons and displayed in different colors. The existing functions of the GIS platform can be used to query, display, count and analyze these objects.

My Concern: The search results that users pay attention to are displayed by default, divided into four categories, including emergency cases, laws and regulations, emergency plans and emergency knowledge.

Hot Search: The top ten of the highest number of keywords searched by all users in the system are displayed, pushed to users actively to facilitate users to search quickly.

History Search: In the intelligent search, the search history of the current users is displayed by default.

What is claimed:

1. An emergency disposal support system is characterized in that:
Configuration Management: Configuration management of database, port number, tables, usernames, passwords and search configuration keyword lists required for intelligent search is realized to provide configuration information for subsequent search functions;
Data Collection and Management: The data are extracted from the configured data sources, the extracted data are temporarily stored, and the extraction process log is recorded. The data after collection can be queried, maintained and re-collected to ensure the quality of the collected data. Information indexing of intelligent search is mainly to establish index terms uniformly for the relevant information within the search scope according to the key values, so as to facilitate the unified management of information and improve the search speed, recall rate and precision rate;
Template Management: The relevant search templates are preset according to the different needs of users, including search topics, keywords, search scope, output results and forms, and subsequently on this basis, and users can modify or use directly. Search keywords can be separated by spaces and multiple keywords can be searched at the same time;
Search and Display: Intelligent search and display output mainly provides users with search according to keywords, search scope and output result set. Corresponding search results can be directly displayed, printed or exported to supply offline users for use;
Statistical Analysis: Statistical analysis of the search situation is made and can be displayed in the form of icons or tables. The number of search results of each type of emergency cases, laws and regulations, emergency plans, emergency knowledge and the total number of search results of the four categories are counted;
My Concern: The search results that users pay attention to are displayed by default, divided into four categories, including emergency cases, laws and regulations, emergency plans and emergency knowledge;
Hot Search: The top ten of the highest number of keywords searched by all users in the system are displayed, pushed to users actively to facilitate users to search quickly;
History Search: In the intelligent search, the search history of the current users is displayed by default;
GIS Display Service: According to the latitude and longitude information of the collected contents, the related content is marked on the GIS map by means of the corresponding icons and displayed in different colors, The existing functions of the GIS platform can be used to query, display, count and analyze these objects.

2. The emergency disposal support system described in the claim 1 is characterized in that the template management mentioned also includes the parameters of template setting such astemplate names, keywords, time, search scope and event types.

3. The emergency disposal support system described in the claim 1 is characterized in that the search and display mentioned also includes the ranking function of intelligent search results which is mainly to sort the search results according to the time and result type but not to change the search results. The search results after sorting are helpful for users to use visually and conveniently.

4. The emergency disposal support system described in the claim 1 is characterized in that the statistical analysis mentioned also includes multiple dimensional statistics according to search type, data source and collection type.
